(19) United States
(12) Patent Application Publication
(10) Pub. No.: US 2016/0125714 A1
(43) Pub. Date: May 5, 2016

(54) VIDEO RECORDING WITH SECURITY/SAFETY MONITORING DEVICE

(71) Applicant: Canary Connect, Inc., New York, NY (US)

(72) Inventors: Sheridan Kates, New York, NY (US); Timothy Robert Hoover, Brooklyn, NY (US); Marc P. Scoffier, Brooklyn, NY (US)

(21) Appl. No.: 14/930,018

(22) Filed: Nov. 2, 2015

Related U.S. Application Data
(60) Provisional application No. 62/074,855, filed on Nov. 4, 2014.

(51) Int. Cl. G08B 13/196; H04N 5/76; H04N 7/18

(52) U.S. Cl. CPC G08B 13/19676; H04N 7/183; H04N 5/76

(57) ABSTRACT

An apparatus includes: a video camera configured to acquire a video of a monitored physical space, a computer-based memory buffer configured to store temporarily a portion of the video acquired by the video camera as it is acquired, and an actuator configured such that operation of the actuator causes, for a period of time, any video subsequently acquired by the video camera to be saved to a computer-based memory device other than the computer-based memory buffer.

### CROSS-REFERENCE TO RELATED APPLICATION(S)

This application claims the benefit of priority to U.S. Provisional Patent Application No. 62/074,855, entitled, Video Recording with Security/Safety Monitoring Device, which was filed on Nov. 4, 2014. The disclosure of the prior application is incorporated by reference herein in its entirety.

### FIELD OF THE INVENTION

This disclosure relates to a security/safety monitoring system and, more particularly, relates to a security/safety monitoring system that is able to capture video recordings of the space being monitored.

### BACKGROUND

Some traditional home security systems use sensors mounted on doors and windows. These systems can sound an alarm and some even include remote monitoring for sounded alarms. These systems, however, fall short on capturing meaningful data, including video, from a monitored space and managing that data in an intelligent manner to maximize system effectiveness.

### SUMMARY OF THE INVENTION

In one aspect, an apparatus includes a video camera configured to acquire a video of a monitored physical space, a computer-based memory buffer configured to store temporarily a portion of the video acquired by the video camera as it is acquired; and an actuator configured such that operation of the actuator causes, for a period of time, any video subsequently acquired by the video camera to be saved to a computer-based memory device other than the computer-based memory buffer.

In a typical implementation, the actuator is further configured such that operation of the actuator causes the portion of the video stored in the computer-based memory buffer when the actuator is operated to be transmitted to the computer-based memory device.

In some implementations, both: a) the portion of the video from the computer-based memory buffer that is saved to the computer-based memory device, and b) the video acquired by the video camera during the period of time following operation of the actuator, are stored together in the computer-based memory device as a single video clip. This single video clip may be accessible and able to be viewed from one or more computer-devices (e.g., user smartphones or the like) that are coupled to the computer-based memory device via a computer-based network.

The apparatus may also include a motion detector configured to detect motion in the monitored physical space. Moreover, in some implementations, the portion of the video stored in the computer-based memory buffer may be saved to the computer-based memory device when the actuator is operated only if the motion detector has detected motion in the monitored physical space during a time that corresponds to the portion of the video that is at the time stored in the computer-based memory buffer.

The apparatus typically includes a housing. Typically, the video camera, the computer-based memory buffer and the actuator are physically coupled, directly or indirectly, to the housing, but the computer-based memory device is not physically coupled to the housing. The computer-based memory device is typically a cloud-based memory device and is coupled to the video camera via a computer-based network (e.g., the Internet).

In some implementations, if the actuator is operated again during the period of time that video is being saved to the more permanent, computer-based memory device, the period of time is extended. In some instances, after the period of time that video is being saved to the computer-based memory device expires, subsequently acquired video is again stored temporarily only in the computer-based memory buffer as it is acquired. The computer-based memory buffer may be configured to store the video as it is acquired on a first-in-first-out basis. Moreover, in some instances, unless the video in the computer-based memory buffer is being transmitted to the computer-based memory device, the video in the computer-based memory buffer is deleted when it is removed from the computer-based memory buffer.

According to certain embodiments, the video camera (or the apparatus) includes a microphone and the acquired video includes an audio component, captured by the microphone, acquired from the monitored physical space.

The actuator can be a switch, such as a touch switch or, more particularly, a capacitive touch switch. The actuator can include a microphone that is responsive to an audio signal (e.g., a spoke command from a person in the monitored space). The audio signal may be processed by a computer-based processor (e.g., inside the monitoring device or in the cloud) to determine, based on the audio signal, whether operation of the actuator has occurred. This audio trigger, in some implementations, may cause, for the period of time, any video subsequently acquired by the video camera to be saved to the computer-based memory device other than the computer-based memory buffer.

In some implementations, the trigger (e.g., operation of the actuator) may cause a notification to be sent or made available to one or more users associated with the monitored physical space that a video of the monitored physical space is available for viewing. The notification may be configured to enable each of the one or more users to view video acquired by the video camera at the monitored physical space from his or her computer-based user interface device.

The notification can be sent to any one or more users associated with the monitored space. In some implementations, the notification is sent only to users associated with the monitored physical space who are not physically at the monitored space (e.g., not home) when the actuator is operated.

The apparatus typically includes a communications module coupled to the computer-based memory buffer and configured to communicate with the computer-based memory device. Moreover, the apparatus may be a security/safety monitoring device that further includes sensors such as one or more of: a temperature sensor, a humidity sensor, an air quality sensor, a motion detector, a smoke detector, a carbon monoxide sensor, and an accelerometer. The video camera may have night vision capability.

In another aspect, a system includes a security/safety monitoring device and a remotely-located computer-based memory device coupled to the security/safety monitoring device via a computer-based network. The security/safety monitoring device may include a video camera configured to acquire a video of a monitored physical space, a computer-based memory buffer configured to store temporarily a portion of the video acquired by the video camera as it is acquired; and an actuator. The actuator may be operable such that operation of the actuator causes, for a period of time, any video subsequently acquired by the video camera to be saved to the remotely-located computer-based memory device.

In yet another aspect, a method includes: acquiring a video of a monitored physical space with a video camera in a security/safety monitoring device, temporarily storing the video as it is acquired in a computer-based memory buffer in the security/safety monitoring device; and in response to a trigger from a actuator that is operable by a person, saving any video subsequently acquired by the video camera, during a specific length of time, to a remotely-located computer-based memory device.

In some implementations, one or more of the following advantages are present.

For example, the systems and functionalities disclosed herein facilitate ease in capturing data about a monitored space so that the captured data can be analyzed by the system and appropriate responses can be implemented, quickly. Moreover, the systems and functionalities disclosed herein enable a person to capture videos of important events (e.g. a child's first steps, etc.) that otherwise might be lost.

Other features and advantages will be apparent from the description and drawings, and from the claims.

### BRIEF DESCRIPTION OF THE DRAWINGS

FIG. 1 is a schematic representation of an exemplary security/safety monitoring system.

FIG. 2 is a perspective view of an exemplary monitoring device.

FIG. 3 is a schematic representation of the internal components of an exemplary monitoring device.

FIG. 4 is a flowchart showing an exemplary process that may be performed by an implementation of the system in FIG. 1.

FIG. 5 is a flowchart showing another exemplary process that may be performed by an implementation of the system in FIG. 1.

FIG. 6 is a schematic representation showing one exemplary first-in-first-out (FIFO) technique that a memory buffer may implement to temporarily store segments of video being acquired by the video camera in the system of FIG. 1.

FIG. 7 shows an example of a person touching an actuator, which in the illustrated example is a capacitive touch switch, on an exemplary monitoring device.

FIG. 8 shows an example of a notification that may be made available to user(s) associated with a monitored location where the actuator on the monitoring device has been operated.

Like reference numerals refer to like elements.

### DETAILED DESCRIPTION

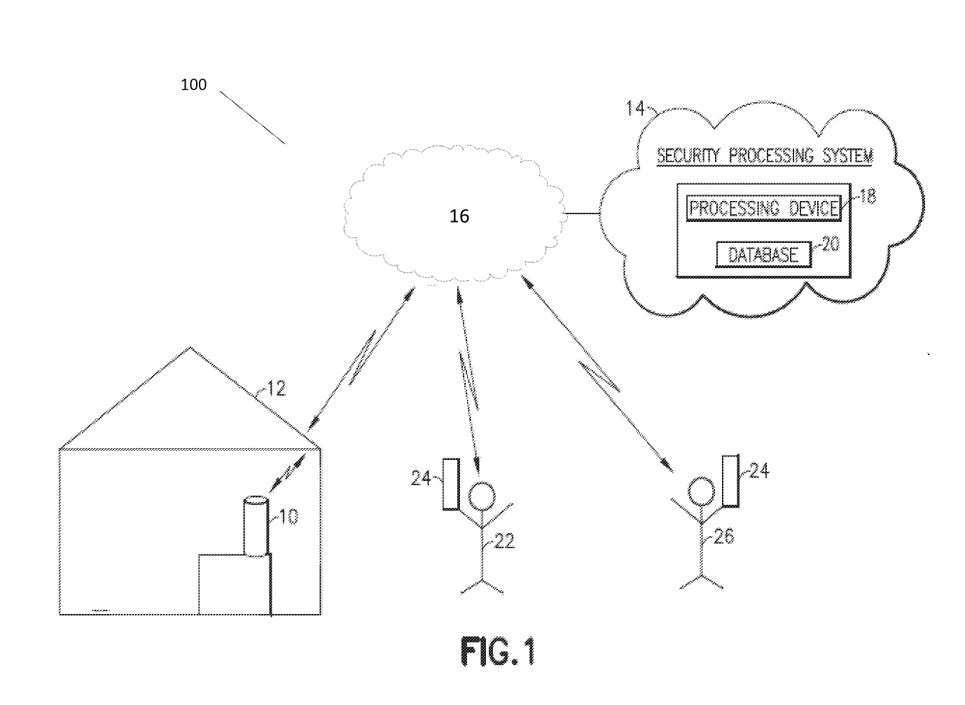

FIG. 1 is a schematic representation of an exemplary security/safety monitoring system 100.

The illustrated system 100 includes a security/safety monitoring device 10. The monitoring device 10 is inside a house 12 and is positioned to monitor various environmental characteristics of a particular physical space inside the house. A remotely-located, computer-based processing system 14 is coupled to the monitoring device 10 via a computer-based network (e.g., the Internet 16) and computer-based user interface devices 24 (e.g., smartphones belonging to different people 22, 26 who live at the house 12, or elsewhere) are coupled to the computer-based processing system 14 via the computer-based network 16. In general, the monitoring device 10, the computer-based processing system 14 and the user interface devices 24 are able to communicate with each other over the computer-based network 16.

Each computer-based user interface device 24 provides a platform upon which the different users can interact with the system 100. In some implementations, the interactions are conducted via a web portal (e.g., a website) and one or more email accounts, or text numbers accessible by the users from their devices 24. In other implementations, the interactions are conducted via an app (i.e., a software application downloaded onto one or more of the devices). In some implementations, the system may facilitate a combination of these, and other, platforms upon which interactions may occur.

The interface may be configured to appear at a user's device in any one of a variety of possible configurations and include a wide variety of different information. For example, in some implementations, the interface may provide for system messaging (e.g., notifications, etc.). It may enable the users to access data about a monitored space (e.g., view videos, and see other data, etc.). The interface may be configured to present a timeline for each user that includes a time line of data (e.g., videos, etc.) captured and organized in a temporal manner. Other variations are possible as well.

The computer-based processing system 14 includes a computer-based processor 18 and a computer-based memory device for storing a database 20.

In general, the illustrated system 100 is operable to monitor the physical space inside the house 12 from a security and safety perspective. In a typical implementation, the monitoring includes active and passive monitoring. Part of this monitoring functionality is performed by a video camera in the monitoring device 10 that is configured to acquire a video of the monitored space. In a typical implementation, anytime the monitoring device 10 is on or powered-up, the video camera is acquiring video. The monitoring device 10 also has a computer-based memory buffer that is configured to store, on a temporary basis, portions of the video being acquired by the video camera. There is an actuator (e.g., a capacitive touch switch) on or associated with the monitoring device 10 that is operable to cause, for a period of time following its operation, any video subsequently acquired by the video camera to be saved to a more permanent computer-based memory device (e.g., 20 in FIG. 1) than the computer-based memory buffer. In a typical implementation, operating the actuator also causes any portions of video saved in the memory buffer to be transferred to the more permanent computer-based memory device 20 as well.

Thus, in a typical implementation, the illustrated system 100 provides safety and security monitoring, but also enables users to capture video recordings (e.g., by operating the capacitive touch switch) of important moments (e.g., baby's first steps, pet being cute, good times with friends etc.), even when the user's smart phone or hand held video recorder (or the like) is not readily available. Moreover, in some implementations, the video recordings can even capture moments that already have passed.

In some implementations, the system 100 is operable such that certain video clips acquired by the video camera are saved to the more permanent memory device 20 even without the user having to operate the actuator on the monitoring device 10. For example, in some implementations, the monitoring device 10 has motion detection capabilities and is operable to transmit a video clip to the more permanent memory device 20 in response to motion having been detected in the monitored space. In some of those implementations, operating the actuator while a particular video clip is being acquired and stored in the more permanent memory device 20 will cause the video clip to be flagged (e.g., to identify that video clip as being significant in some way).

In a typical implementation, the monitoring device 10 has multiple sensors (detectors) including, for example, the video camera, which may include a microphone (and, optionally, night vision capability) and a motion detector. Some implementations include one or more of the following: a temperature sensor, a humidity sensor, an air quality sensor, a smoke detector, a carbon monoxide sensor, an accelerometer, etc. Moreover, in a typical implementation, the monitoring device 10 has a communications module to facilitate communicating with other system components (e.g., the computer-based processing system 14, one or more of the computer-based user interface devices 24 and/or other components including ones not shown in FIG. 1). Additionally, in a typical implementation, the monitoring device 10 has an internal computer-based processor and computer-based memory storage capacity besides the memory buffer.

In a typical implementation, the system 100 is able to be operated in any one of several different operating modes. For example, according to one implementation, the system 100 has three different operating modes: armed mode, in which the disarmed mode, and privacy mode.

In armed mode, the monitoring device 10 is powered on. Typically, in armed mode, the camera of the monitoring device is armed and enabled and the microphone of the monitoring device is armed and enabled. Moreover, the monitoring device 10 is looking for motion. In a typical implementation, upon detecting motion (or at least certain types of motion), the monitoring device starts uploading video data to the cloud service (e.g., security processing system 114) and sends push notification(s), or other communications, to one or more (or all) of the primary users, and/or backup contacts, associated with the monitored location where the motion has been detected with a call to action for those users to view the detected motion via the app or website. Any uploaded videos may be saved to a person's timeline.

In disarmed mode, the system acts in a manner very similar to the way the system acts in armed mode, one of the most notable differences being that, in disarmed mode, no notifications are sent to any of the users.

In privacy mode, the monitoring device 10 is powered on. However, it is generally not monitoring or recording any information about the space where it is located. In privacy mode, the camera is off and any listening devices (e.g., a microphone, etc.) are off; no video or audio is being recorded, and no users are really able to remotely view the space where the monitoring device 10 is located. Moreover, when the system 100 is in privacy mode, if a user accesses the system (e.g., through an app on their smartphone, or at a web-based portal), a “watch live” functionality that ordinarily would allow the user to see the monitored space is simply not available.

In a typical implementations, the operating modes may be controlled by a user through a software app (e.g., on the user's mobile device) and a user (e.g., a primary user associated with a monitored location) may switch the system between operating modes by interacting on the app.

The computer-based user interface devices 24 can be any kind of computer-based devices that a person might use to access information over a network (e.g., the Internet 16). In the illustrated example, the computer-based user interface devices 24 are smartphones. However, in other implementations, the computer-based user interface devices can be or include tablets, cell phones, laptop computers and/or desktop computers, etc. Two smartphones 24 are shown in the illustrated example. Of course, in various implementations, the system 100 may include any number of smartphones (or other type of user interfaces). In the illustrated example, each smartphone 24 belongs to (or is primarily operated by) a corresponding one of the illustrated persons 22, 26.

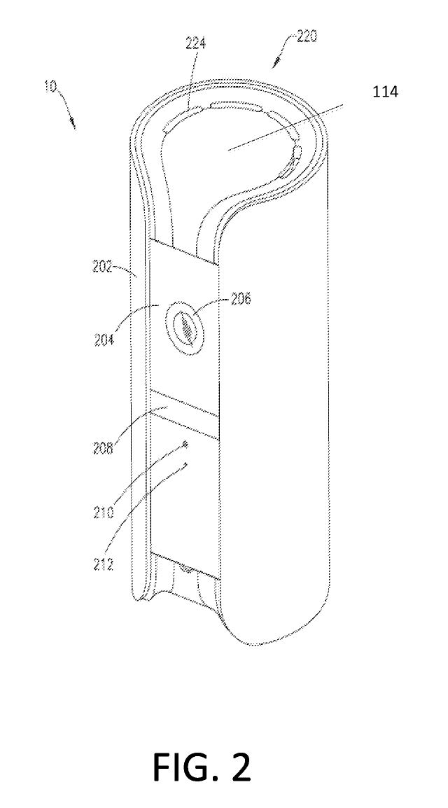

FIG. 2 is a perspective view of an exemplary monitoring device 10.

The illustrated device 10 has an outer housing 202 and a front plate 204. In this example, the front plate 204 defines a first window 206, which is in front of an image sensor (e.g., a video camera), second window 208, which is rectangular in this example, is in front of an infrared LED array. An opening 210 is in front of an ambient light detector, and opening 212 is in front of a microphone. The front plate 204 may be a black acrylic plastic, for example. The black plastic acrylic plastic in some implementations would be transparent to near IR greater than 800 nm.

In the illustrated example, the actuator 114 is at the top surface of the monitoring device 10. The actuator 144 shown in the illustrated example is a capacitive touch switch. The capacitive-touch switch is not at all visible on the outer surface of the monitoring device 10 and, therefore, does not negatively affect the aesthetic appeal of the device. The actuator does not need to be a capacitive touch switch. Any kind of user-actuated trigger could be used including, for example, any kind of touch-activated button (or actuator), other type of physical button or switch, a voice-actuated trigger, motion-actuated trigger, etc.

In some implementations, what happens when the actuator is operated (e.g., touched) depends in part on what type of service the user has established. Also, what happens when the actuator is touched depends in part on what the monitoring device is doing when the switch is touched.

To provide some context regarding the environment in which the capacitive-touch button operates, in a typical implementation, absent some triggering event that causes the monitoring device to operate differently, anytime the device is on, the monitoring device is acquiring video (including sound), which is placed into a memory buffer (which may be inside the monitoring device 10). In a typical implementation, the buffer holds some length of video in discrete segments and operates using first-in-first-out (FIFO) functionality. In one example, the buffer is configured to store ten seconds of video, in five 2 second segments. In this example, absent some triggering event that causes the monitoring device 10 to operate differently, video is continuously fed into the buffer in two-second segments with the older two-second segment in the buffer being deleted every time a new two-second segment moves into the buffer. In this operating mode, any two-second segment of video that leaves the buffer is deleted forever.

The buffer is described here as storing ten seconds of video in five two-second segments. However, in other implementations, the buffer may be configured to store any other amount of data (or data corresponding to any specific duration) in any number of segments having any specific duration.

Typically, other sensor data collected by the monitoring device may be continually sent to remotely-located processing system 14 (e.g., via AMQP protocol) for storage and/or further processing. In general, the other sensor data (e.g., temperature data, air quality data, etc.) is continually transmitted from the monitoring device 10 to the remotely-located processing system 14 because doing so requires very little bandwidth, particularly as compared to transmitting video.

In one operational mode, operating the actuator 114 causes the monitoring device 10 to start saving subsequently acquired video (e.g., for up to a minute and a half) to the more permanent memory destination (i.e., the memory device 20 in the remotely-located processing system 14). In addition, in this operational mode, operating the actuator 114 also cause the monitoring device 10 to transfer video that is in the memory buffer (e.g., a ten second segment of video from right before the actuator was operated) to the memory device 20 in the remotely-located processing system 14.

In a typical implementation, both: a) the portion of the video from the computer-based memory buffer, and b) the video acquired by the video camera during the period of time following operation of the actuator, are stored together in the computer-based memory device as a single video clip. Moreover, the single video clip typically is accessible and able to be viewed from one or more of the user computer-devices (24 is FIG. 1) that are coupled to the computer-based memory device 14 via a computer-based network 16.

In some, but not necessarily all, implementations, while the monitoring device 10 is saving video to the more-permanent destination (e.g., 20, in the cloud), the monitoring device 10 provides some kind of indication that this is occurring. This can be done in a variety of ways. As an example, in some implementations, an LED on the monitoring device 10 may provide a visual indication that a more permanent recording of video being acquired is being saved. Alternatively, the indication could be an audible one, a tactile one or any other kind or combination of indication that a person near the device 10 might be able to recognize.

In the example being discussed, sometime near (e.g., within about 10 or 15 seconds of) the end of the one and a half minute permanent recording period, the monitoring device 10 may, in a typical implementation, provide some kind of (visual, audible and/or tactile, e.g., with an LED) indication that the recording period will soon come to an end. This can be done in a variety of ways. As an example, an LED on the monitoring device 10 may provide a visual indication that the recording period is approaching an end.

Continuing this particular example, if, before the end of the more permanent recording period (i.e., one and a half minutes in this example), a person again operates the actuator (e.g., touches the capacitive touch switch), then the monitoring device 10 extends the more permanent recording period some additional length of time (e.g., another one and a half minutes).

Once any user-initiated recording period (i.e., period during which the acquired video is being sent to a more permanent storage destination than the local buffer) ends, the monitoring device 10 resumes directing the video it acquires into the local buffer using FIFO functionality.

In some implementations, any video clips that are saved in the more permanent memory device (i.e., 20 in FIG. 1), are preserved (for later viewing and/or downloading) until the user deletes them or until the system deletes them. In some implementations, there is a limit on the number of videos (or total size of video clips) that the system 100 will preserve for certain users. In one example, a user will be limited to long-term storing up to five video clips.

If the system 100 reaches the video clip storage limit for a particular location/user, and the user attempts to save another clip for that location, the system 100 may, in some implementations, store the new clip for some relatively short amount of time (e.g., a few hours, day or a week, etc.) and send the user(s) a message (e.g., via push technology, email and/or text) that at least one of the video clips needs to be deleted. If the user does not delete one of the video clips within a designated amount of time after the message is sent (e.g., within a day or a week), then the system 100 may delete one of the video clips for that location on its own (e.g., the last video clip saved for that location or user).

In some implementations, the monitoring device 10 and overall system 100 may operate a bit differently. In these implementations, again, absent some triggering event that causes the monitoring device 10 to operate differently, anytime the device is on, the video camera is acquiring video (including sound), which is placed into a memory buffer using FIFO functionality.

For segments of video acquired, a computer-based processor (or motion detector) inside the monitoring device 10 determines, based on the video acquired (and perhaps based on other sensor data), whether there is motion in the space being monitored. In this example, anytime the monitoring device 10 senses motion, it begins transmitting the video being acquired to the more permanent storage destination (e.g., 20 in FIG. 1). The computer-based processor in the monitoring device 10 also may quantify (e.g., with a numerical or alpha score or the like) a degree (or extent) of motion represented by a particular video clip or frame.

In this example, after the monitoring device 10 detects motion, some length of video (e.g., a minute, a minute and a half, two minutes, etc.) is transmitted to the memory device 20 as it is acquired.

In some implementations, the monitoring device 10 also transmits to the remotely-located processing system 14 information that quantifies the motion detected in the video transmitted. In some implementations, the processor 18 at the remotely-located processing system 14 may independently quantify motion represented in a video clip it receives and compare its independent quantification with the quantification received from the monitoring device. In this way, the remotely-located processing system 14 can check the accuracy of the usually lower-processing-power processor/motion detector in the monitoring device 10. Moreover, this check can, in some instances, be used to correct/adjust the techniques used by the monitoring device 10 to detect and quantify motion.

In a typical implementation where the monitoring device 10 sends video clips to the remotely-located memory device 20 in response to motion (or some other trigger) being detected in the monitored space, any of the video clips sent to the memory device 20 may be saved for some period of time (e.g., up to twelve hours, or a day or a week). After that period of time expires for a particular video clip, the video clip is deleted.

In a typical implementation, the processing device 18 has relatively high processing power, particularly as compared to the processing power that may be available at the monitoring device 10. In some implementations, the processing device 18 uses computer vision processing to determine whether the video captured and sent to the cloud actually represents a level of actual motion that is potentially of interest to the system. In this regard, the cloud processor essentially checks the accuracy of the determination made at the monitoring device processor.

Continuing this example, if the monitoring device 10 is transmitting video as it is acquired to the remotely-located memory storage device 20 in response to motion having been detected in the monitored space, then operating the actuator essentially flag the video clip (e.g., for later viewing, ease of finding, etc.). In general, flagging a clip makes it easy to find later on by the user. If a user flags sections of video he or she considers to be important, these flagged sections of video can be easily accessed (for viewing, etc.) at a later point in time.

In a typical implementation, if the user in this example operates the actuator again before a flagged section of video (e.g., a one and a half minute or so section of video) finishes, the monitoring device 10 will extend the flagged section of video an additional period of time (e.g., an additional one and a half minutes).

Referring again to FIG. 2, the top 220 of the monitoring device 10 also includes outlet vents 224 through the top to allow for airflow out of the device 10. In a typical implementation, the bottom of the device includes inlet vents to allow airflow into the device 10. The top 220 and the bottom of the device 10 may be separate, plastic pieces that are attached to the housing 202 or an internal housing during assembly, for example. During operation, air passing through the bottom, inlet vents travels through the device 10, where it picks up heat from the internal components of the device, and exits through the top, outlet vents 224. In this example hot air rises through the device 10, causing air to be drawn into the device from the bottom vents and to exit out of the top vents 224. A fan may be provided to draw external air into the device 10 through the bottom, inlet vents and/or to drive the air out of the device through the top, outlet vents 224.

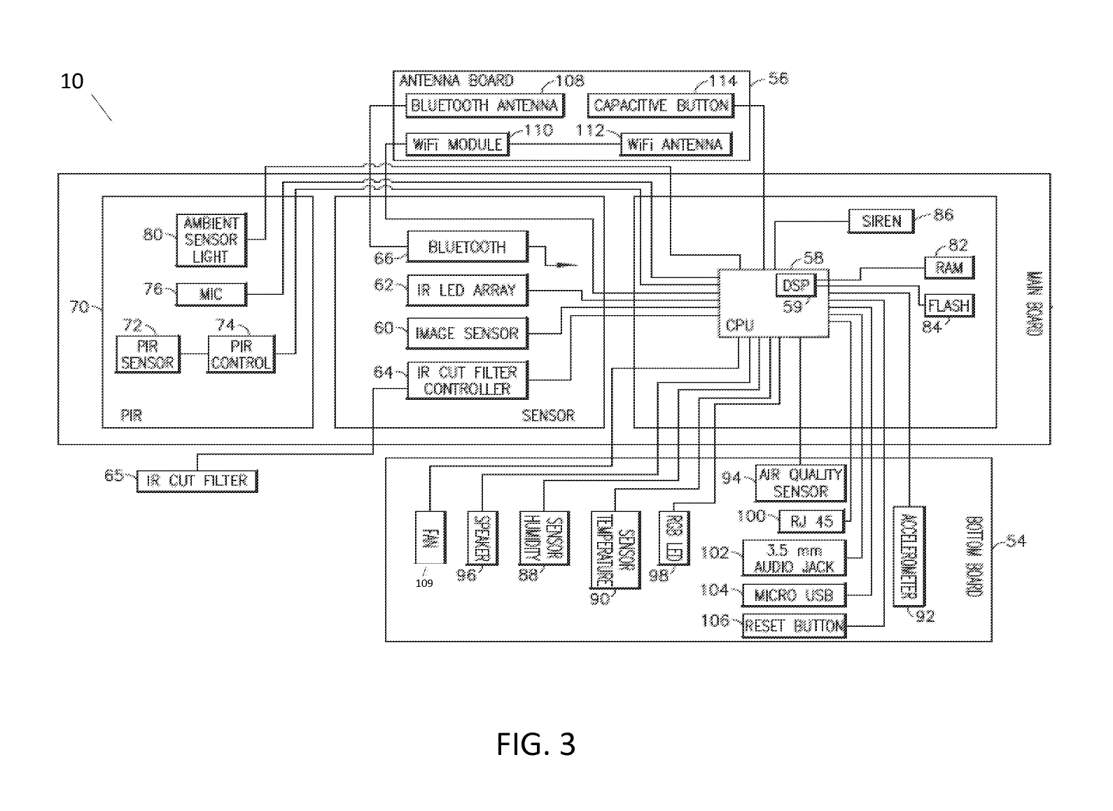

In a typical implementation, the device 10 shown in FIG. 2 includes circuitry, internal components and/or software to perform and/or facilitate the functionalities disclosed herein. An example of the internal components, etc. in one implementation of the device 10 is shown in FIG. 3.

In FIG. 3, the illustrated device 10 has a main printed circuit board (“PCB”), a bottom printed circuit board 54, and an antenna printed circuit board 56. A processing device 58 (e.g., a central processing unit (“CPU”)), is mounted to the main PCB. The processing device may include a digital signal processor (“DSP”) 59. The CPU 58 may be an Ambarella digital signal processor, A5x, available from Ambarella, Inc., Santa Clara, Calif., for example.

An image sensor 60 of a camera (e.g., capable of acquiring video), an infrared light emitting diode (“IR LED”) array 62, an IR cut filter control mechanism 64 (for an IR cut filter 65), and a Bluetooth chip 66 are mounted to a sensor portion of the main board, and provide input to and/or receive input from the processing device 58. The main board also includes a passive IR (“PIR”) portion 70. Mounted to the passive IR portion 70 are a KR sensor 72, a PIR controller 74, such as a microcontroller, a microphone 76, and an ambient light sensor 80. Memory, such as random access memory (“RAM”) 82 and flash memory 84 may also be mounted to the main board. The memory in the monitoring device 10 includes the buffer memory referred to herein. A siren 86 may also be mounted to the main board. In some implementations, certain components the PIR sensor 72 and the PIR controller) may be omitted.

A humidity sensor 88, a temperature sensor 90 (which may be combined into a combined humidity/temperature sensor), an accelerometer 92, and an air quality sensor 94, are mounted to the bottom board 54. A speaker 96, a red/green/blue (“RGB”) LED 98, an RJ45 or other such Ethernet port 100, a 3.5 mm audio jack 102, a micro USB port 104, and a reset button 106 are also mounted to the bottom board 54. A fan 109 is also provided.

A communications module includes a Bluetooth antenna 108, a WiFi module 110 and a WiFi antenna 112 mounted to the antenna board 56. A capacitive touch switch 114 (i.e., the actuator referred to herein) is also mounted to the antenna board 56.

In various implementations, the components may be mounted to different boards.

In general, the monitoring device 10 in FIGS. 2 and 3 is operable to acquire data about the physical space where the monitoring device 10 is located and communicate (e.g., using the communications module(s) at 56 or other communications modules) with other system components to perform and/or support various functionalities disclosed herein. In some implementations, the processor 58 is configured to perform at least some of the processing described herein. In some implementations, the processing device 18 (at the remotely-located computer-based processing system 14) is configured to perform at least some of the processing described herein. In some implementations, processor 58 and processor 18 work in conjunction to perform the processing described herein.

Other exemplary monitoring devices and/or environments in which the systems, techniques and components described herein can be incorporated, deployed and/or implemented are disclosed in pending U.S. patent application Ser. No. 14/260,264, entitled System and Methods for Designating and Notifying Secondary Users for Location-Based Monitoring, which is incorporated by reference in its entirety herein.

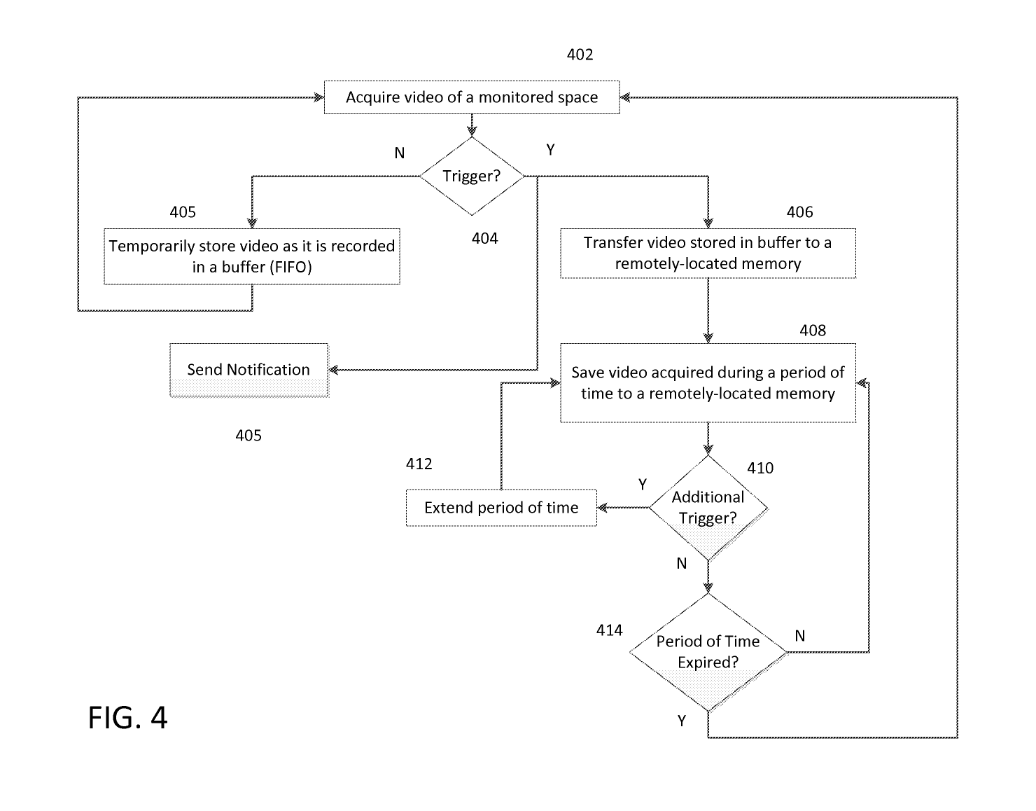

FIG. 4 is a flowchart showing an exemplary process that may be performed by an implementation of the system 100 in FIG. 1. In a typical implementation, the process represented in the exemplary flowchart would be available when the system is operating in armed mode or disarmed mode. In some implementations, the process may be available in privacy mode as well.

According to the illustrated process, the monitoring device 10 acquires video (at 402) of monitored space. In a typical implementation, absent any kind of trigger to cause the monitoring device to operate differently, segments of the video being acquired are saved (at 405), temporarily, as they are acquired in a memory buffer within (or associated with) the monitoring device 10. This is done, in a typical implementation, on a FIFO basis. However, other approaches, besides FIFO are possible as well.

If (at 404) a trigger occurs (e.g., the capacitive touch switch 114 is operated, or motion of interest s detected in the monitored space), then the monitoring device 10 transfers (at 406) any video in the buffer to a remotely-located (more permanent) memory (e.g., 20 in FIG. 1). Additionally, subsequent video acquired during a period of time following the trigger is saved (408) to the remotely-located memory (e.g., 20) as well.

Additionally, in response to the trigger (at 404), which may occur when a user presses the actuator, the system 100 sends (at 405) a notification (e.g., that the trigger has occurred and/or indicating that there is video that the user should watch) to one or more (or all) of the users (primary and/or backup contacts) associated with that location. More particularly, these notifications are transmitted to (or made available at) the users' computer devices (e.g., smartphones or the like), via push notification, email, text, etc. In some implementations, the system 100 sends that notification to any other users of that location—other than the user who pressed the actuator and/or any other users that may be in the monitored location when the actuator is pressed. In a typical implementation, the system 100 includes a processing device (either in the monitoring device or in the cloud) that can determine which users are home (e.g., in the monitored location) and which users are not. So the notification may only be sent to the users who are not in the monitored location (home). This may be used in a lifestyle-type scenario (e.g., when a child who gets home from school and presses the capacitive touch button to send a notification to his or her parents that says ‘Someone wants you to see what's happening at [location.name].’) This feature may also be used in a scenario where there is a security/safety event happening. In this example the actuator (button) may serve as a sort of “panic button” that would notify all other users that ‘Someone wants you to see what's happening at [location.name].’ In that instance a user could sound the siren or call the police or emergency services when they see from the notification that something bad is happening in the monitored location.

If (at 410) an additional trigger occurs (e.g., a user operates the actuator) during the designated period of time, then the period of time is extended (at 412). Otherwise, after the period of time expires (at 414), the monitoring device (at 402) simply resumes acquiring video (and saving it to the buffer using a FIFO approach).

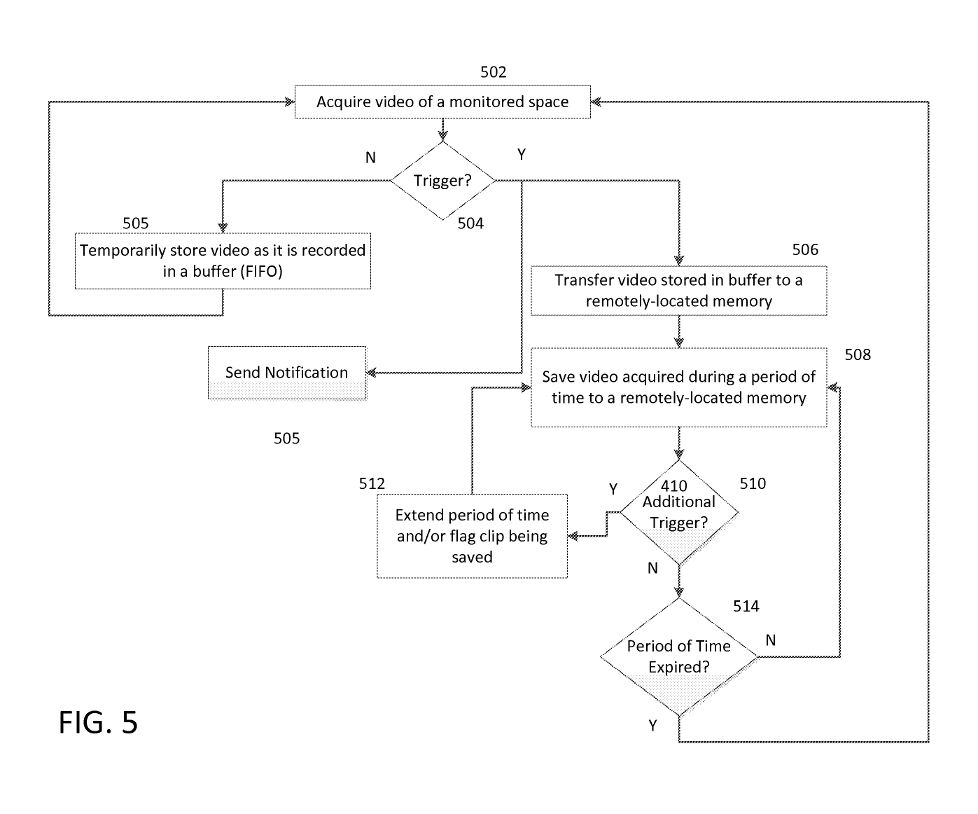

FIG. 5 is a flowchart showing another exemplary process that may be performed by an implementation of the system 100 in FIG. 1.

According to the illustrated process, the monitoring device 10 acquires video (at 502) of a monitored space. In a typical implementation, absent any kind of trigger detecting some kind of motion of interest in the monitored space) to cause the monitoring device to operate differently, segments of the video being acquired are saved (at 505), temporarily, as they are acquired in a memory buffer within (or associated with) the monitoring device 10. This is done, in a typical implementation, on a FIFO basis.

If (at 504) a trigger occurs (e.g., motion of interest is detected in the monitored space or the user presses the actuator), then the monitoring device 10 transfers (at 506) any video in the buffer to a remotely-located (more permanent) memory (e.g., 20 in FIG. 1). Additionally, subsequent video acquired during a period of time following the trigger is saved (508) to the remotely-located memory (e.g., 20) as well.

Additionally, in response to the trigger (at 504), which may occur when a user presses the actuator, the system 100 sends (at 505) a notification (e.g., that the trigger has occurred and/or indicating that there is video that the user should watch) to one or more (or all) of the users (primary and/or backup contacts) associated with that location. More particularly, these notifications are transmitted to (or made available at) the users' computer devices (e.g., smartphones or the like), via push notification, email, text, etc. In some implementations, the system 100 sends that notification to any other users of that location—other than the user who pressed the actuator and/or any other users that may be in the monitored location when the actuator is pressed. In a typical implementation, the system 100 includes a processing device (either in the monitoring device or in the cloud) that can determine which users are home (e.g., in the monitored location) and which users are not. So the notification may only be sent to the users who are not in the monitored location (home).

If (at 510) an additional trigger occurs (e.g., a user operates actuator) during the designated period of time, then: 1) the period of time may be extended (at 512), and/or 2) the video clip being saver to the remotely-located memory storage device 20 is flagged. Otherwise, after the period of time expires (at 514), the monitoring device (at 502) simply resumes acquiring video (and saving it to the buffer using a FIFO approach).

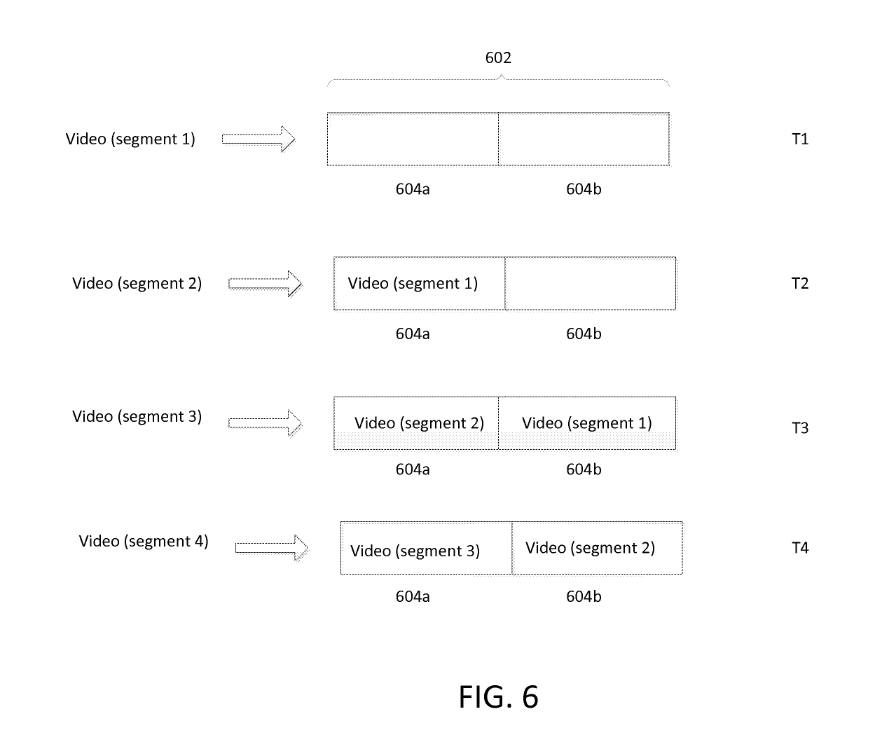

FIG. 6 is a schematic representation showing one exemplary first-in-first-out (FIFO) technique that the memory buffer may implement to temporarily store segments of video being acquired by the video camera.

The illustrated buffer 602 has two portions 604a, 604b. Each portion 604a, 604b of the buffer in the illustrated example has enough storage capacity to store approximately 5 seconds of video. Thus, the overall buffer has enough storage capacity to store approximately 10 second of video.

According to the illustrated example, at time T1, a first video segment (segment 1) is being directed into the buffer 602. The first video segment (segment 1) in the illustrated example is approximately 5 seconds long.

At time T2, the first video segment (segment 1) is in the first portion 604a of the buffer 602 and a second video segment (segment is being directed into the buffer 602. The second video segment (segment 2) in the illustrated example is approximately 5 seconds long as well.

At time T3, the first video segment (segment 1) has shifted to the second portion 604b of the buffer 602 and the second video segment (segment 2) is in the first portion 604a. Moreover, a third video segment (segment 3) is being directed into the buffer 602. The third video segment (segment 3) in the illustrated example is approximately 5 seconds long as well.

At time T4, the first video segment (segment 1) has shifted out of the buffer (and effectively been deleted), the second video segment (segment 2) has shifted to the second portion 604b of the buffer 602, and the third video segment (segment 3) is in the first portion 604a of the buffer 602. Moreover, a fourth video segment (segment 4) is being directed into the buffer 602. The fourth video segment (segment 4) in the illustrated example is approximately 5 seconds long as well.

In a typical implementation, any time a triggering event occurs (e.g., the actuator is operated or motion of interest has been detected in the monitored space), whatever video segments are in the buffer are transmitted to the remotely-located memory storage device 20. If, for example, the actuator is operated at time T3, then the second and third video segments (segment 2 and segment 3) are transmitted to memory device 20.

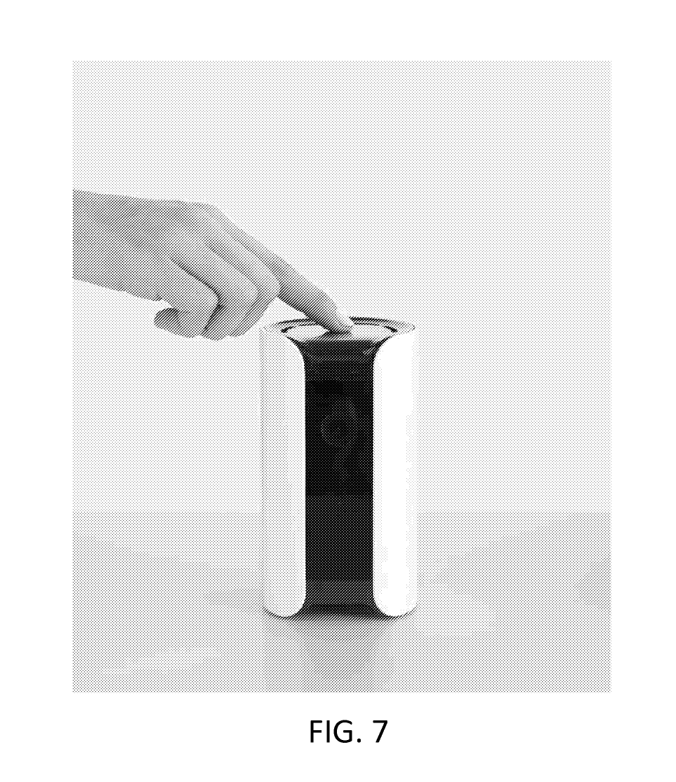

FIG. 7 shows an example of a person touching an actuator, which in the illustrated example is a capacitive touch switch, on an exemplary monitoring device.

In some implementations, the system 100 is operable such that when the actuator is operated, thereby causing, for a period of time, any video subsequently acquired by the video camera to be saved to a remotely-located computer-based memory device (e.g., at 14 in FIG. 1), the system notifies one or more users who are associated with the monitored space that this has happened. In some implementations, the notification is made available to every user who is associated with (i.e., who lives at or owns) the particular monitored location. In some implementations, the notification is made available to only a certain subset of users associated with the particular monitored location (e.g., only those users who are not physically located at the monitored location when the actuator is operated).

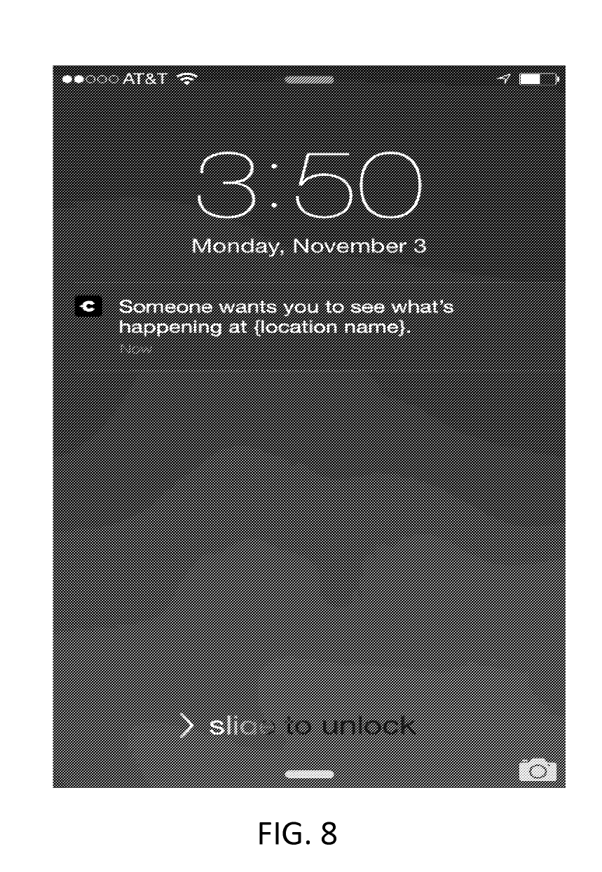

FIG. 8 shows an example of a notification that may be made available to user(s) associated with a monitored location where the actuator on the monitoring device has been operated. In illustrated example, the notification is a push notification that can be viewed on a user's mobile device and reads, “Someone wants you to see what's happening at {location name}.” In a real message, {location name} would identify the monitored location with some degree of specificity (e.g., “at home”).

In a typical implementation, a notification like the one shown in FIG. 8 would only be sent once in a designated amount of time (e.g., once per minute), even if the actuator s operated more than once in that designated amount of time. Also, in a typical implementation, when the user opts to engage with the notification (e.g., by manipulating the “slide to unlock” feature on the interface shown in FIG. 8), the system 100 presents a screen to the user that enables the user to view the monitored location (e.g., live or substantially live).

In some implementations, when a person touches the capacitive touch switch, as shown in FIG. 7, for a specific amount of time (e.g., at least one full second), a light emitting diode (or some other visual, tactile or audible indicator) on the monitoring device operates to indicate that the touch has successfully initiated the desired functionality and that a notification has been sent to one or more users associated with the monitored location. Notably, this functionality may or may not be available when the system is operating in certain operating modes. For example, in some implementations, this functionality may not be available when the system is operating in privacy mode. In other implementations, this functionality may be available when the system is operating in privacy mode.

A numb of embodiments of the invention have been described. Nevertheless, it will be understood that various modifications may be made without departing from the spirit and scope of the invention.

For example, the lengths of time for various items mentions herein can vary. Moreover, the types of triggers and triggering devices can vary. For example, in some implementations, the trigger may be an audio trigger. In this example, a user who is present in the monitored space could utter a word, phrase or make a sound that the system (using a microphone and processor in the monitoring device, for example) might recognize as a trigger. In this kind of example a user could say ‘Canary, record now,’ and the monitoring device/system would follow the above descriptions of how it records and may auto-flag any captured recordings. It would also send the notifications to users.

The physical appearance of various items, including their dimensions, relative and actual, can vary.

Additionally, certain aspects of the recording functionalities disclosed herein occur in response to a user operating a capacitive touch switch provided at the monitoring device. The capacitive touch switch facilitates easy operation—generally, a user simply taps the switch to initiate the associated recording functionalities. However, a variety of other types of switches may be used in lieu of the capacitive touch switch.

Moreover, the buffer disclosed herein operates using first-in-first-out (FIFO) functionality. However, in some implementations, the buffer may use functionality other than FIFO. For example, older video may be prioritized (and, therefore, stored in the buffer for a longer period of time) if certain criteria are satisfied (e.g., that the older video is considered important for one or more reasons).

Embodiments of the subject matter and the operations described in this specification can be implemented in digital electronic circuitry, or in computer software, firmware, or hardware, including the structures disclosed in this specification and their structural equivalents, or in combinations of one or more of them. Embodiments of the subject matter described in this specification can be implemented as one or more computer programs, i.e., one or more modules of computer program instructions, encoded on computer storage medium for execution by, or to control the operation of, data processing apparatus. Alternatively or in addition, the program instructions can be encoded on an artificially generated propagated signal, e.g., a machine-generated electrical, optical, or electromagnetic signal that is generated to encode information for transmission to suitable receiver apparatus for execution by a data processing apparatus.

Computer-readable instructions to implement one or more of the techniques disclosed herein be stored on a computer storage medium. Computer storage mediums (e.g., a non-transitory computer readable medium) can be, or be included in, a computer-readable storage device, a computer-readable storage substrate, a random or serial access memory array or device, or a combination of one or more of them. Moreover, while a computer storage medium is not a propagated signal, a computer storage medium can be a source or destination of computer program instructions encoded in an artificially-generated propagated signal. The computer storage medium can also be, or be included in, one or more separate physical components or media (e.g., multiple CDs, disks, or other storage devices).

The operations described in this specification can be implemented as operations performed by a data processing apparatus on data stored on one or more computer-readable storage devices or received from other sources. The term “data processing apparatus” (e.g., a processor or the like) encompasses all kinds of apparatus, devices, and machines for processing data, including by way of example a programmable processor, a computer, a system on a chip, or multiple ones, or combinations, of the foregoing. Moreover, use of the term data processing apparatus should be construed to include multiple data processing apparatuses working together. Similarly, use of the term memory or memory device or the like should be construed to include multiple memory devices working together.

Computer programs (also known as programs, software, software applications, scripts, or codes) can be written in any form of programming language, including compiled or interpreted languages, declarative or procedural languages, and can be deployed in any form.

The processes and logic flows described in this specification can be performed by one or more programmable processors executing one or more computer programs to perform actions by operating on input data and generating output. Processors suitable for the execution of a computer program include, by way of example, both general and special purpose microprocessors, and any one or more processors of any kind of digital computer. Generally, a processor will receive instructions and data from a read only memory or a random access memory or both.

A computer device adapted to implement or perform one or more of the functionalities described herein can be embedded in another device, e.g., a mobile telephone, a personal digital assistant (PDA), a mobile audio or video player, a game console, a Global Positioning System (GPS) receiver, or a portable storage device (e.g., a universal serial bus (USB) flash drive), to name just a few.

Devices suitable for storing computer program instructions and data include all forms of nonvolatile memory, media and memory devices, including, for example semiconductor memory devices, e.g., EPROM, EEPROM, and flash memory devices; magnetic disks, e.g., internal hard disks or removable disks; magneto optical disks; and CD ROM and DVD-ROM disks.

To provide for interaction with a user, embodiments of the subject matter described in this specification can be implemented using a computer device having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input.

While this specification contains any specific implementation details, these should not be construed as limitations on the scope of any inventions or of what may be claimed, but rather as descriptions of features specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings and described herein in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

The phrase “motion of interest” and similar phrases are used herein. In a typical implementation, “motion of interest” can be any type of motion that may be relevant, for example, to the security or safety monitoring functionalities of the monitoring device.

Motion sensing can be done in a variety of ways. In some instances, motion sensing is performed by using a computer-based processor to analyze video acquired by the video camera. In some instances, motion sensing is performed by detecting changes in light from the monitored space. Other techniques may be used as well.

Other implementations are within the scope of the claims.

What is claimed is:

1. An apparatus comprising:
a video camera configured to acquire a video of a monitored physical space;
a computer-based memory buffer configured to store temporarily a portion of the video acquired by the video camera as it is acquired; and
an actuator configured such that operation of the actuator causes, for a period of time, any video subsequently acquired by the video camera to be saved to a computer-based memory device other than the computer-based memory buffer.

2. The apparatus of claim 1, wherein the actuator is further configured such that operation of the actuator causes the portion of the video stored in the computer-based memory buffer when the actuator is operated to be transmitted to the computer-based memory device.

3. The apparatus of claim 2, wherein both:
a) the portion of the video from the computer-based memory buffer that is saved to the computer-based memory device, and
b) the video acquired by the video camera during the period of time following operation of the actuator,
are stored in the computer-based memory device as a single video clip.

4. The apparatus of claim 3, wherein the single video clip is accessible and able to be viewed from one or more computer-devices that are coupled to the computer-based memory device via a computer-based network.

5. The apparatus of claim 2, further comprising:
a motion detector configured to detect motion in the monitored physical space.

6. The apparatus of claim 5, wherein the portion of the video stored in the computer-based memory buffer is saved to the computer-based memory device when the actuator is operated only if the motion detector has detected motion in the monitored physical space during a time that corresponds to the portion of the video stored in the computer-based memory buffer.

7. The apparatus of claim 1 further comprising:
a housing, wherein the video camera, the computer-based memory buffer and the actuator are physically coupled, directly or indirectly, to the housing, but the computer-based memory device is not physically coupled to the housing,
wherein the computer-based memory device is coupled to the video camera via a computer-based network.

8. The apparatus of claim 1, wherein the actuator is further configured such that if the actuator is again operated during the period of time that the video is being saved to the computer-based memory device, the period of time is extended.

9. The apparatus of claim 1, wherein after the period of time that video is being saved to the computer-based memory device expires, subsequently acquired video is stored temporarily only in the computer-based memory buffer as it is acquired.

10. The apparatus of claim 1, wherein the computer-based memory buffer stores the video as it is acquired on a first-in-first-out basis.

11. The apparatus of claim 10, wherein, unless the video in the computer-based memory buffer is being transmitted to the computer-based memory device, the video in the computer-based memory buffer is deleted when it is removed from the computer-based memory buffer.

12. The apparatus of claim 1, wherein the video camera includes a microphone and the acquired video includes an audio component acquired from the monitored physical space.

13. The apparatus of claim 1, wherein the actuator is a switch.

14. The apparatus of claim 13, wherein the switch is a touch switch.

15. The apparatus of claim 1, wherein operation of the actuator further causes a notification to be sent to one or more users associated with the monitored physical space that a video of the monitored physical space is available for viewing.

16. The apparatus of claim 15, wherein the notification is configured to enable each of the one or more users to view video acquired by the video camera at the monitored physical space from his or her computer-based user interface device.

17. The apparatus of claim 15, wherein the notification is sent only to users associated with the monitored physical space who are not home when the actuator is operated.

18. The apparatus of claim 1, further comprising:
a communications module coupled to the computer-based memory buffer and configured to communicate with the computer-based memory device.

19. The apparatus of claim 1, wherein the apparatus is a security/safety monitoring device and further comprises a plurality of sensors including one or more of: a temperature sensor, a humidity sensor, an air quality sensor, a motion detector, a smoke detector, a carbon monoxide sensor, and an accelerometer.

20. The apparatus of claim 1, wherein the video camera has night vision capability.

21. The apparatus of claim 1, wherein the actuator comprises a microphone that is responsive to an audio signal, wherein the audio signal is processed by a computer-based processor to determine, based on the audio signal, whether operation of the actuator has occurred so as to cause, for the period of time, any video subsequently acquired by the video camera to be saved to the computer-based memory device other than the computer-based memory buffer.

22. A system comprising:
a security/safety monitoring device that comprises
a video camera configured to acquire a video of a monitored physical space; and
a computer-based memory buffer configured to store temporarily a portion of the video acquired by the video camera as it is acquired; and
an actuator; and
a remotely-located computer-based memory device coupled to the security/safety monitoring device via a computer-based network,
wherein the actuator is operable such that operation of the actuator causes, for a period of time, any video subsequently acquired by the video camera to be saved to the remotely-located computer-based memory device.

23. The system of claim 22, wherein the actuator is further operable such that operation of the actuator causes the portion of the video stored in the computer-based memory buffer when the actuator is operated to be transmitted to the remotely-located computer-based memory device.

24. The system of claim 23, wherein both:
a) the portion of the video from the computer-based memory buffer that is saved to the computer-based memory device, and
b) the video acquired by the video camera during the period of time following operation of the actuator,
are stored in the remotely-located computer-based memory device so that they can be viewed as a single video clip from any one of a plurality of computer-devices that are coupled to the computer-based memory device via the computer-based network.

25. The system of claim 23, wherein the security/safety monitoring device further comprises a motion detector configured to detect motion in the monitored physical space,
wherein the portion of the video stored in the computer-based memory buffer is saved to the remotely-located computer-based memory device when the actuator is operated only if the motion detector has detected motion in the monitored physical space during a time that corresponds to the portion of the video stored in the computer-based memory buffer.

26. The system of claim 22, wherein the security/safety monitoring device further comprises:
a housing,
wherein the video camera, the computer-based memory buffer and the actuator are physically coupled, directly or indirectly, to the housing, but the remotely-located computer-based memory device is not physically coupled to the housing.

27. The system of claim 22, wherein the actuator is further configured such that if the actuator is again operated during the period of time that any video being acquired is being saved to the remotely-located computer-based memory device, the period of time is extended.

28. The system of claim 22, wherein the security/safety monitoring device is further configured such that after the period of time that video is being saved to the computer-based memory device has expired, until the actuator is operated again, subsequently acquired video is stored temporarily only in the computer-based memory buffer as it is acquired.

29. The system of claim 22, wherein the security/safety monitoring device is further configured such that video acquired into the computer-based memory buffer is on a first-in-first-out basis.

30. The system of claim 29, wherein, unless the video in the computer-based memory buffer is being transmitted to the remotely-located computer-based memory device, the video in the computer-based memory buffer is deleted when it is removed from the computer-based memory buffer.

31. The system of claim 22, wherein the video camera includes a microphone and the acquired video includes an audio component acquired by microphone from the monitored physical space.

32. The system of claim 22, wherein the actuator is a switch.

33. The system of claim 32, wherein the switch is a touch switch.

34. The system of claim 22, wherein operation of the actuator further causes a notification to be sent to one or more users associated with the monitored physical space, but not physically present in the monitored physical space, that a video recording of the monitored physical space is available for viewing.

35. The apparatus of claim 33, wherein the notification is configured to enable each of the one or more users to view video acquired by the video camera at the monitored physical space from his or her computer-based user interface device.

36. The system of claim 22, wherein the security/safety monitoring device further comprises:
a communications module coupled to the computer-based memory buffer and operable to communicate with the remotely-located computer-based memory device.

37. The system of claim 22, wherein the security/safety monitoring device further comprises
a plurality of sensors including one or more of: a temperature sensor, a humidity sensor, an air quality sensor, a motion detector, an accelerometer, a smoke detector and a carbon monoxide sensor.

38. The system of claim 22, wherein the video camera has night vision capability.

39. A method comprising:
acquiring a video of a monitored physical space with a video camera in a security/safety monitoring device;
temporarily storing the video as it is acquired in a computer-based memory buffer in the security/safety monitoring device; and
in response to a trigger from a actuator that is operable by a person, saving any video subsequently acquired by the video camera, during a specific length of time, to a remotely-located computer-based memory device.

40. The method of claim 39, further comprising:
in response to the trigger, causing any portion of video stored in the computer-based memory buffer to be saved to the remotely-located computer-based memory device.

41. The method of claim 40, further comprising:
transmitting the video subsequently acquired by the video camera, during a specific length of time, to the remotely-located computer-based memory device for saving via a computer-based network; and/or
transmitting any portion of video stored in the computer-based memory buffer to the remotely-located computer-based memory device for saving via the computer-based network.

42. The method of claim 40, further comprising:
storing both:
a) the portion of the video from the computer-based memory buffer that is saved to the remotely-located computer-based memory device, and
b) the video acquired by the video camera during the period of time following the trigger,
in the remotely-located computer-based memory device so as to be accessible and able to be viewed as a single video clip from one or more computer-devices that are coupled to the computer-based memory device via a computer-based network.

43. The method of claim 40, further comprising:
detecting motion in the monitored physical space with a motion detector; and
saving the portion of video stored in the computer-based memory buffer at the remotely-located computer-based memory device when the actuator is operated only if the motion detector detected motion in the monitored physical space during a time that corresponds with the portion of the video that was stored in the computer-based memory buffer.

44. The method of claim 40, wherein the security/safety monitoring device comprises:
a housing, wherein the video camera, the computer-based memory buffer and the actuator are physically coupled, directly or indirectly, to the housing, but the computer-based memory device is not physically coupled to the housing,
wherein the remotely-located computer-based memory device is coupled to the video camera via a computer-based network.

45. The method of claim 40, wherein the actuator is further configured such that if the actuator is again operated during the period of time that the video is being saved to the computer-based memory device, the period of time is extended.

46. The method of claim 40, wherein after the period of time that video is being saved to the computer-based memory device expires, subsequently acquired video is stored temporarily only in the computer-based memory buffer.

47. The method of claim 40, wherein storing the video as it is acquired in the computer-based memory buffer is on a first-in-first-out basis.

48. The method of claim 47, further comprising:
deleting the video from the computer-based memory buffer unless the video in the computer-based memory buffer is transmitted to the remotely-located computer-based memory device.

49. The method of claim 40, wherein the video camera includes a microphone, the method further comprising:
acquiring an audio component from the monitored physical space as part of the video.

50. The method of claim 40, wherein the trigger originates from a person operating a actuator on the security/safety monitoring device, wherein the actuator is a touch actuator.

51. The method of claim 40, further comprising:
sensing from the monitored space with the security/safety monitoring device one or more of: temperature, humidity, air quality, motion, acceleration, a smoke detector and carbon monoxide.
